(19) United States
(12) Patent Application Publication
(10) Pub. No.: US 2011/0196052 A1
(43) Pub. Date: Aug. 11, 2011

(54) FLAME RETARDANTS

(75) Inventors: Klaus Hahn, Kirchheim (DE); Olaf Kriha, Neustadt (DE); Ingo Bellin, Manheim (DE); Patrick Spies, Neustadt (DE); Sabine Fuchs, Mannheim (DE); Peter Deglmann, Mannheim (DE); Klemens Massonne, Bad Durkheim (DE); Hartmut Denecke, Ludwigshafen (DE); Christoph Fleckenstein, Freigericht (DE); Geert Janssens, Friedelsheim (DE); Maximilian Hofmann, Mannheim (DE)

(73) Assignee: BASF SE, Ludwigshafen (DE)

(21) Appl. No.: 13/022,045

(22) Filed: Feb. 7, 2011

Related U.S. Application Data
(60) Provisional application No. 61/301,691, filed on Feb. 5, 2010.

(51) Int. Cl. C08K 5/5398; C08L 25/06; C08J 9/18; C08J 9/12

(52) U.S. Cl. 521/56; 524/122; 524/134; 521/85; 521/146

(57) ABSTRACT

Phosphine sulfide derivatives of the formula (I),

S═PR¹R²R³ (I)

are suitable as flame retardants, in particular for polymers, where the definitions of the symbols in the formula (I) are as follows:
R¹ and R² are identical or different, being C₁-C₁₂-alkyl, C₃-C₈-cycloalkyl, which may have no substitution or may have one or more C₁-C₄-alkyl groups as substituents, C₂-C₁₂-alkenyl, C₂-C₁₂-alkynyl, C₆-C₁₀-aryl, or C₈-C₁₀-aryl-C₁-C₄-alkyl;
R³ is H, SH, SR⁴, OH, OR⁵ or a —(Y¹)ₙ—[P(═X¹)R⁶—(Y²)ₙ]ₘ—P(═X²)R⁷R⁸ group;
or two groups R¹, R², R³ form, together with the phosphorus atom bonded thereto, a ring system;
X¹ and X² are identical or different, being O or S;
Y¹ and Y² are identical or different, being O or S;
R⁴, R⁵, R⁶, R⁷ and R⁸ are identical or different, being independently from one another C₁-C₁₂-alkyl, C₃-C₈-cycloalkyl, which may have no substitution or may have one or more C₁-C₄-alkyl groups as substituents, C₂-C₁₂-alkenyl, C₂-C₁₂-alkynyl, C₆-C₁₀-aryl, or C₆-C₁₀-aryl-C₁-C₄-alkyl;
n is 1 if Y¹ and, respectively, Y² is O, and is 1, 2, 3, 4, 5, 6, 7, or 8 if Y¹ and, respectively, Y² is S, and
m is an integer from 0 to 100.

The invention relates to the use of phosphine sulfide derivatives as flame retardants, and also to polymers, in particular foams, which comprise said flame retardants.

The provision of flame retardants to polymers, in particular foams, is important for a wide variety of applications, for example for molded polystyrene foams made of expandable polystyrene (EPS), or extruded polystyrene foam sheets (XPS) for the insulation of buildings.

The flame retardants currently used in plastics are mainly polyhalogenated hydrocarbons, if appropriate in combination with suitable synergists, for example organic peroxides or nitrogen-containing compounds. A typical representative of these traditional flame retardants is hexabromocyclododecane (HBCD), which is used by way of example in polystyrene. The plastic industry is making great efforts to find replacements for halogenated flame retardants, because of bioaccumulation, and also because some polyhalogenated hydrocarbons are persistent materials.

Flame retardants should ideally exhibit not only a high level of flame-retardant action in the plastic at a low level of loading but also adequate resistance to heat and hydrolysis for processing purposes. They should also exhibit an absence of bioaccumulation and persistency.

WO-A 2009/035881 and WO-A 2008/088487 describe halogen-free flame retardants having sulfur-phosphorus bonds, in particular thiophosphates and thiophosphonates.

However, there remains much scope for improvements in such flame retardants, for example because the amounts that have to be used of halogen-free flame retardants are generally markedly higher if they are to achieve the same flame-retardant effect as halogen-containing flame retardants. In the case of polymer foams it is therefore also often impossible to use halogen-free flame retardants that can be used for thermoplastic polymers, such as polystyrene, because they either disrupt the foaming process or affect the mechanical and thermal properties of the polymer foam. When expandable polystyrene is produced via suspension polymerization, the large amounts of flame retardant can moreover reduce the stability of the suspension. Furthermore, it is often impossible to predict what effect the flame retardants used for thermoplastic polymers will have in polymer foams, because of differences in fire behavior and in the fire tests used.

It is therefore the object of the invention to provide compounds which are firstly halogen-free and secondly, even when the amounts used are small, exhibit good flame retardancy properties in polymers, in particular in polymer foams, such as EPS and XPS.

It has been found that certain phosphine sulfide derivatives, in particular certain derivatives of dithiophosphinic acid, have particular suitability for use as flame retardants.

The invention therefore provides the use of phosphine sulfide derivatives of the formula (I)

S═PR¹R²R³ (I)

as flame retardants, in particular for polymers, where the definitions of the symbols in the formula (I) are as follows:
R¹ and R² are identical or different, being C₁-C₁₂-alkyl, C₃-C₈-cycloalkyl, which may have no substitution or may have one or more C₁-C₄-alkyl groups as substituents, C₂-C₁₂-alkenyl, C₂-C₁₂-alkynyl, C₆-C₁₀-aryl, or C₈-C₁₀-aryl-C₁-C₄-alkyl;
R³ is H, SH, SR⁴, OH, OR⁵ or a —(Y¹)ₙ—[P(═X¹)R⁶—(Y²)ₙ]ₘ—P(═X²)R⁷R⁸ group;
or two groups R¹, R² and R³ form, together with the phosphorus atom bonded thereto, a ring system;
X¹ and X² are identical or different, being O or S;
Y¹ and Y² are identical or different, being O or S;
R⁴, R⁵, R⁶, R⁷ and R⁸ are identical or different, being independently from one another C₁-C₁₂-alkyl, C₃-C₈-cycloalkyl, which may have no substitution or may have one or more C₁-C₄-alkyl groups as substituents, C₂-C₁₂-alkenyl, C₂-C₁₂-alkynyl, C₆-C₁₀-aryl, or C₈-C₁₀-aryl-C₁-C₄-alkyl;
n is 1 if Y¹ and, respectively, Y² is O, and is 1, 2, 3, 4, 5, 6, 7, or 8 if Y¹ and, respectively, Y² is S, and
m is an integer from 0 to 100.

The invention further provides a process for rendering foamed and unfoamed polymers flame-retardant, where a flame retardant comprising one or more compounds of the formula (I) is added to the polymer.

The invention equally provides a polymer composition comprising a flame retardant which comprises one or more compounds of the formula (I).

The invention further provides the use, as insulating materials, of certain foamed polymer compositions which comprise the flame retardant of the invention.

The compounds of the formula (I) are halogen-free and, even when the amounts used are small, have markedly better effectiveness in foams than halogen-free flame retardants known hitherto, e.g. dibenz[c,e][1,2]-oxaphosphorine 6-oxide (DOP, see, for example, EP-A 1 791 896).

It is preferable that the definitions of the symbols and indices in the formula (I) are as follows:
R¹ and R² are preferably identical or different, being C₁-C₈-alkyl, cyclohexyl, phenyl or benzyl;
R³ is preferably H, SH, SR⁴ or a —(Y¹)ₙ—[P(═X¹)R⁶—(Y²)ₙ]ₘ—P(═X²)R⁷R⁸ group.

It is also preferable that two groups R¹, R², R³ form, together with the phosphorus atom bonded thereto, a ring system.
X¹ and X² are preferably S.
Y¹ and Y² are preferably identical or different, being O or S.
R⁴, R⁶, R⁷ and R⁸ are preferably identical or different, being independently of one another C₁-C₈-alkyl, cyclohexyl, phenyl or benzyl.
n is preferably 1 if Y¹ and, respectively Y² is O, and is preferably 1 or 2 if Y² is S.
m is preferably an integer from 0 to 10.

Preference is given to compounds of the formula (I) in which the definitions of all of the symbols and indices are the preferred definitions.

It is particularly preferable that the definitions of the symbols and indices in the formula (I) are as follows:
R¹ and R² are particularly preferably phenyl.
R³ is particularly preferably H, SH, S-benzyl, or a (Y¹)ₙ—P(═S)R⁷R⁸ group.
Y¹ is particularly preferably identical or different, being O or S.
R⁷ and R⁸ are particularly preferably phenyl.
n is particularly preferably 1 if Y¹ is O, and is particularly preferably 1 or 2 if
Y¹ is S.

Particular preference is given to compounds of the formula (I) in which the definitions of all of the symbols and indices are the particularly preferred definitions.

Preference is also given to compounds of the formula (I) in which R³ is SH, SR⁴, OH, OR⁵, or a —(Y¹)ₙ—[P(═X¹)R⁶—(Y²)ₙ]ₘ—P(═X²)R⁷R⁸ group.

Preference is also given to compounds of the formula (I) in which R³ is SH, SR⁴, or a —(Y¹)ₙ—[P(═X¹)R⁶—(Y²)ₙ]ₘ—P(═X²)R⁷R⁸ group, where Y¹═S.

Preference is also given to compounds of the formula (I) in which R³ is a —(Y¹)ₙ—[P(═X¹)R⁶—(Y²)ₙ]ₘ—P(═X²)R⁷R⁸ group, and it is particularly preferable here that Y¹ is S.

Preference is also given to compounds of the formula (I) in which R³ is SH.

Preference is also further given to compounds of the formula (I) in which two moieties R¹, R²; R³ do not together form a ring system.

Preference is also given to compounds of the formula (I) in which respectively two of the moieties R¹, R²; R³ form, together with the phosphorus atom bonded thereto, a three- to twelve-membered ring system.

Preference is further given to the following groups of compounds of the formula (I):

S═PR¹R²—H (Ia);

S═PR¹R²—SH (Ib);

S═PR¹R²—S-benzyl (Ic);

S═PR¹R²—S—P(═S)R⁷R⁸ (Ida);

S═PR¹R²—S—S—P(═S)R⁷R⁸ (Idb) and

S═PR¹R²—O—P(═S)R⁷R⁸ (Idc),

where the definitions of the symbols are as stated in the formula (I).

Preference is also given to compounds of the formula (I) in which R¹ and R² are identical.

Preference is also given to compounds of the formula (I) in which R⁷ and R⁸ are identical.

Particular preference is given to compounds of the formula (I) in which R¹, R², R⁷, and R⁸ are identical.

Particularly preferred compounds of the formula (I) are the compounds FSM 1 to FSM 6 listed in the examples.

It is preferable to use 1 compound of the formula (I) as flame retardant.

Preference is further given to a mixture of two or more, particularly preferably from two to four, in particular two, compounds of the formula (I) as flame retardants.

Some of the compounds of the formula (I) are commercially available, an example being diphenyldithiophosphinic acid (FSM 1) from ABCR GmbH & Co. KG, Karlsruhe, Germany. They can moreover be produced by known methods familiar to the person skilled in the art, for example those described in Houben-Weyl, Methoden der Organischen Chemie [Methods of organic chemistry], 5th edition, Georg Thieme Verlag, Stuttgart 2001. Reference is further made to the references in the examples section in relation to the synthesis of compounds FSM 2 to FSM 6.

Oligomers and polymers (m=2 to 100) are obtainable by way of example via reaction of halophosphates with dialcohols, as described in WO 2008/027536.

The amounts used of the compounds of the formula (I) used in the invention are generally in the range from 0.1 to 25 parts by weight. Sufficient flame retardancy is ensured in particular in the case of foams made of expandable polystyrene by using amounts of from 2 to 15 parts by weight, preferably from 2.5 to 10 parts by weight.

For the purposes of this application, unless otherwise stated, parts by weight data are always based on 100 parts by weight of the compound, in particular the polymer, to which flame retardancy is provided, without taking any additives into account.

The effectiveness of the compounds (I) can be still further improved by adding suitable flame retardant synergists, e.g. the following thermal free-radical generators: dicumyl peroxide, di-tert-butyl peroxide, or biscumyl(2,3-diphenyl-2,3-dimethylbutane). It is usual here to use from 0.05 to 5 parts by weight of the flame retardant synergist in addition to the compound(s) (I).

Preference as synergist is further given to elemental sulfur, this proportion preferably being from 0.05 to 4 parts by weight, particularly preferably from 0.1 to 2.5 parts by weight.

The elemental sulfur can also be used in the form of starting compounds which decompose to give elemental sulfur under the conditions of the process.

Another possibility is use of elemental sulfur in encapsulated form. Examples of materials suitable for the encapsulation process are melamine resins (by analogy with U.S. Pat. No. 4,440,880) and urea-formaldehyde resins (by analogy with U.S. Pat. No. 4,698,215). WO 99/10429 gives further materials and references.

It is also possible to use further flame retardants, examples being melamine, melamine cyanurates, metal oxides, and metal hydroxides, and further examples being phosphates, phosphonates, phosphinates, and expandable graphite, or synergists, such as compounds that comprise or liberate nitroxyl radicals, or Sn compounds, or Sb₂O₃. Suitable additional halogen-free flame retardants are by way of example commercially available as Exolit OP 930, Exolit OP 1312, HCA, HCA-HQ, M-Ester Cyagard RF-1241, Cyagard RF-1243, Fyrol PMP, Phoslite IP-A (aluminium hypophosphite), Melapur 200, Melapur MC, APP (ammonium polyphosphate) and Budit 833.

If complete freedom from halogen is not essential, reduced-halogen-content materials can be produced by using the compounds (I) of the invention and adding relatively small amounts of halogen-containing, in particular brominated, flame retardants, such as hexabromocyclododecane (HBCD), or brominated styrenehomo- or copolymers/oligomers (e.g. styrene-butadiene copolymers as described in WO-A 2007/058736) preferred amounts of these being from 0.05 to 1 part by weight, in particular from 0.1 to 0.5 part by weight.

A preferred embodiment is, therefore, the use of the invention, where the compound(s) of formula (I) are used in mixture with one or more further flame retarding compounds and/or with one or more synergists.

In one preferred embodiment, the flame retardant of the invention is halogen-free.

It is particularly preferable that the composition made of polymer, flame retardant, and further additives is halogen-free.

The flame retardants of the invention, i.e. compounds of the formula (I), alone or in a mixture with one another, and, respectively, in a mixture with synergists, and, respectively, in a mixture with further flame-retardant substances, are used in the invention for producing materials provided with flame retardancy, preferably unfoamed or foamed polymers, in particular thermoplastic polymers. For this, the flame retardant is preferably mixed physically with the corresponding polymer in the melt and then in the form of polymer mixture, with phosphorus contents of from 0.05 part by weight to 5 parts by weight, first subjected to a finishing process and then, in a second step, further processed together with the same or another polymer. Alternatively, in the case of styrene polymers, addition of the compounds of the invention (I) before, during and/or after production by suspension polymerization is also preferred.

The invention further provides a, preferably thermoplastic, polymer composition comprising a flame retardant of the invention, comprising one or more compounds of the formula (I).

The thermoplastic polymer used can by way of example comprise foamed or unfoamed styrene polymers, inclusive of ABS, ASA, SAN, AMSAN, polyesters, polyimides, polysulfones, polyolefins, such as polyethylene and polypropylene, polyacrylates, polyetheretherketones, polyurethanes, polycarbonates, polyphenylene oxides, and unsaturated polyester resins, phenolic resins, polyamides, polyether sulfones, polyether ketones, and polyether sulfides, in each case individually or in a mixture in the form of polymer blends.

Preference is given to foamed or unfoamed styrene homopolymers and foamed or unfoamed styrene copolymers, respectively individually or in a mixture in the form of polymer blends.

Preference is given to flame-retardant polymer foams, in particular those based on styrene polymers, preferably EPS and XPS.

The density of the flame-retardant polymer foams is preferably in the range from 5 to 200 kg/m³, particularly preferably in the range from 10 to 50 kg/m³, and it is preferable that the proportion of closed cells in the foams is more than 80%, particularly from 90 to 100%.

The flame-retardant, expandable styrene polymers (EPS) and extruded styrene polymer foams (XPS) of the invention can be processed by addition of a blowing agent and the flame retardant of the invention before, during and/or after suspension polymerization or by mixing to incorporate a blowing agent and the flame retardant of the invention into the polymer melt and subsequent extrusion and pelletization under pressure to give expandable pellets (EPS), or via extrusion and depressurization using appropriately shaped dies to give foam sheets (XPS) or foam strands.

The expression “styrene polymer” in the invention comprises polymers based on styrene, alpha-methylstyrene, or a mixture of styrene and alpha-methylstyrene; by analogy, this applies to the styrene content in SAN, AMSAN, ABS, ASA, MBS, and MABS (see below). Styrene polymers of the invention are based on at least 50% by weight of styrene and/or alpha-methylstyrene monomers.

In one preferred embodiment, the polymer is an expandable polystyrene (EPS).

In another preferred embodiment, the foam is an extruded polystyrene foam (XPS).

The molar mass of expandable styrene polymers is preferably in the range from 120 000 to 400 000 g/mol, particularly preferably in the range from 180 000 to 300 000 g/mol, measured by means of gel permeation chromatography to DIN 55672-1 with refractiometric detection (RI) against polystyrene standards. Because of degradation of molar mass caused by shear and/or heat, the molar mass of the expandable polystyrene is generally below that of the polystyrene used by about 10 000 g/mol.

Styrene polymers preferably used comprise glassclear polystyrene (GPPS), impact-resistant polystyrene (HIPS), anionically polymerized polystyrene or impact-resistant polystyrene (ATPS), styrene-α-methylstyrene copolymers, acrylonitrile-butadiene-styrene polymers (ABS), styrene-acrylonitrile copolymers (SAN), acrylonitrile-alpha-methylstyrene copolymers (AMSAN), acrylonitrile-styrene-acrylate (ASA), methyl acrylate-butadiene-styrene (MBS), or methyl methacrylate-acrylonitrile-butadiene-styrene (MABS) polymers, or a mixture of these or with polyphenylene ether (PPE).

In order to improve mechanical properties or resistance to temperature change, the styrene polymers mentioned can be blended with thermoplastic polymers, such as polyamides (PA), polyolefins, such as polypropylene (PP) or polyethylene (PE), polyacrylates, such as polymethyl methacrylate (PMMA), polycarbonate (PC), polyesters, such as polyethylene terephthalate (PET) or polybutylene terephthalate (PBT), polyether sulfones (PES), polyether ketones or polyether sulfides (PES), or a mixture thereof, generally in total proportions of at most 30 parts by weight, preferably in the range from 1 to 10 parts by weight, based on the polymer melt, with use of compatibilizers, if appropriate. It is also possible to produce mixtures in the ranges of amounts mentioned with, for example, hydrophobically modified or functionalized polymers or oligomers, or rubbers, such as polyacrylates or polydienes, e.g. with styrene-butadiene block copolymers or with biodegradable aliphatic or aliphatic/aromatic copolyesters.

Examples of suitable compatibilizers are maleic anhydride-modified styrene copolymers, polymers containing epoxy groups, or organosilanes.

The styrene polymer melt can also receive admixtures of polymer recyclates of the thermoplastic polymers mentioned, in particular styrene polymers and expandable styrene polymers (EPS) in amounts that do not significantly alter the properties of the polymer, the amounts generally being at most 50 parts by weight, in particular amounts of from 1 to 20 parts by weight.

The styrene polymer melt comprising blowing agent generally comprises a total proportion of from 2 to 10 parts by weight, preferably from 3 to 7 parts by weight, based on 100 parts by weight of the styrene polymer melt, of one or more blowing agents homogeneously distributed. Suitable blowing agents are the physical blowing agents usually used in EPS, examples being aliphatic hydrocarbons having from 2 to 7 carbon atoms, alcohols, ketones, ethers, and halogenated hydrocarbons. It is preferable to use isobutane, n-butane, isopentane, or n-pentane. For XPS, it is preferable to use CO₂ or a mixture thereof with alcohols and/or with C₂-C₄-carbonyl compounds, in particular with ketones.

In order to improve foamability, it is possible to introduce finely distributed droplets of internal water into the styrene polymer matrix. This can by way of example be achieved by adding water to the molten styrene polymer matrix. The location of addition of the water can be upstream of, identical with, or downstream of the location of blowing agent feed. Homogeneous distribution of the water can be achieved by means of dynamic or static mixers. A sufficient amount of water is generally from 0 to 2 parts by weight, preferably from 0.05 to 1.5 parts by weight.

When expandable styrene polymers (EPS) with at least 90% of the internal water in the form of droplets of internal water of diameter in the range from 0.5 to 15 μm are foamed they form foams with an adequate cell number and with homogeneous foam structure.

The amount of blowing agent and water added is selected in such a way that the expansion capability a of the expandable styrene polymers (EPS), defined as bulk density prior to the foaming process/bulk density after the foaming process is at most 125, preferably from 25 to 100.

The bulk density of the expandable styrene polymer pellets (EPS) of the invention is generally at most 700 g/l, preferably in the range from 590 to 660 g/l. When fillers are used, bulk densities in the range from 590 to 1200 g/l can occur as a function of the nature and amount of the filler.

Other materials that can be added to the styrene polymer melt, together or with spatial separation, for example by way of mixers or ancillary extruders, are additives, nucleating agents, fillers, plasticizers, soluble and insoluble inorganic and/or organic dyes and pigments, e.g. IR absorbers, such as carbon black, graphite, or aluminum powder. The amounts generally added of the dyes and pigments are in the range from 0.01 to 30 parts by weight, preferably in the range from 1 to 5 parts by weight. For homogeneous and microdispersed distribution of the pigments within the styrene polymer it can be advisable particularly in the case of polar pigments to use a dispersing agent, e.g. organosilanes, epoxidized polymers, or maleic-anhydride-grafted styrene polymers. Preferred plasticizers are mineral oils and phthalates, the amounts of which that can be used are from 0.05 to 10 parts by weight. Analogously, these compounds can be added before, during and/or after suspension polymerization to EPS according to the invention.

To produce the expandable styrene polymers of the invention according to the granulation process, the blowing agent can be incorporated by mixing into the polymer melt. One possible process comprises the stages of a) melt production, b) mixing, c) cooling, d) conveying, and e) pelletization. Each of said stages can be executed by using the apparatuses or apparatus combinations known within plastics processing. Static or dynamic mixers, such as extruders, are suitable for the incorporation-by-mixing process. The polymer melt can be taken directly from a polymerization reactor, or can be produced directly within the mixing extruder or within a separate melting extruder, via melting of polymer pellets. The melt can be cooled in the mixing assemblies or in separate coolers. Examples of the equipment that can be used for the pelletization process are pressurized underwater pelletizers, pelletizers having rotating blades and cooling via spray-misting of coolant liquids, or pelletization with atomization.

Examples of suitable arrangements of apparatus for conduct of the process are:
a) polymerization reactor-static mixer/cooler-pelletizer
b) polymerization reactor-extruder-pelletizer
c) extruder-static mixer-pelletizer
d) extruder-pelletizer

The arrangement may also have ancillary extruders for introducing additives, e.g. solids or heat-sensitive additives.

The temperature of the styrene polymer melt comprising blowing agent when it is passed through the die plate is generally in the range from 140 to 300° C., preferably in the range from 160 to 240° C. Cooling to the region of the glass transition temperature is not necessary.

The die plate is heated at least to the temperature of the polystyrene melt comprising blowing agent. The temperature of the die plate is preferably above the temperature of the polystyrene melt comprising blowing agent, by from 20 to 100° C., in order to avoid polymer deposits in the dies, and to ensure problem-free pelletization.

In order to obtain marketable pellet sizes, the diameter (D) of the holes in the die at the outlet of the die should be in the range from 0.2 to 1.5 mm, preferably in the range from 0.3 to 1.2 mm, particularly preferably in the range from 0.3 to 0.8 mm. This permits targeted adjustment to pellet sizes below 2 mm, in particular in the range from 0.4 to 1.4 mm, even after die swell.

Particular preference is given to a process for producing expandable styrene polymers (EPS) provided with halogen-free flame retardancy, comprising the following steps
a) mixing to incorporate an organic blowing agent and, preferably, from 1 to 25 parts by weight of the flame retardant of the invention into the polymer melt by means of a static or dynamic mixer at a temperature of at least 150° C.,
b) cooling of the blowing agent-containing styrene polymer melt to a temperature of at least 120° C.,
c) discharge through a die plate with holes, the diameter of which at the exit from the die is at most 1.5 mm, and
d) pelletizing the melt comprising blowing agent directly behind the die plate under water at a pressure in the range from 1 to 20 bar.

It is also preferred to produce the expandable styrene polymers (EPS) of the invention via suspension polymerization in aqueous suspension in the presence of the flame retardant of the invention and of an organic blowing agent.

In the case of the suspension polymerization process, it is preferable that styrene is the sole monomer used. However, up to 20% of the weight of styrene can have been replaced by other ethylenically unsaturated monomers, such as alkylstyrenes, divinylbenzene, acrylonitrile, 1,1-diphenyl ether, or alpha-methylstyrene.

The usual auxiliaries can be added during the suspension polymerization process, examples being peroxide initiators, suspension stabilizers, blowing agents, chain-transfer agents, expansion aids, nucleating agents, and plasticizers. The amounts of the flame retardant of the invention added in the polymerization process are from 0.5 to 25% by weight, preferably from 5 to 15% by weight. The amounts of blowing agents added are from 2 to 10% by weight, based on monomer. These amounts can be added prior to, during, or after polymerization of the suspension. Suitable blowing agents are aliphatic hydrocarbons having from 4 to 6 carbon atoms. It is advantageous to use inorganic Pickering dispersants as suspension stabilizers, an example being magnesium pyrophosphate or calcium phosphate.

The suspension polymerization process produces bead-shaped particles which are in essence round, with average diameter in the range from 0.2 to 2 mm.

In order to improve processability, the finished expandable styrene polymer pellets can be coated with glycerol ester, antistatic agent, or anticaking agent.

The EPS pellets can be coated with glycerol monostearate GMS (typically 0.25 part by weight), glycerol tristearate (typically 0.25 part by weight), Aerosil R972 fine-particle silica (typically 0.12 part by weight), or Zn stearate (typically 0.15 part by weight), or else antistatic agent.

The expandable styrene polymer pellets of the invention can be prefoamed in a first step by means of hot air or steam to give foam beads of density in the range from 5 to 200 kg/m³, in particular from 10 to 50 kg/m³, and can be fused in a second step in a closed mold to give molded-foam moldings.

The expandable polystyrene particles can be processed to give polystyrene foams with densities from 8 to 200 kg/m³, preferably from 10 to 50 kg/m³. For this, the expandable particles are prefoamed. This is mostly achieved via heating of the particles with steam in what are known as prefoamers. The resultant prefoamed beads are then fused to give moldings. For this, the prefoamed beads are placed in molds which do not give a gas-tight seal and are treated with steam. The moldings can be removed after cooling.

In another preferred embodiment, the foam is an extruded polystyrene (XPS) obtainable via:
(a) heating of a polymer component P to form a polymer melt,
(b) introducing a blowing agent component T into the polymer melt to form a foamable melt,
(c) extruding the foamable melt into a region of relatively low pressure with foaming to give an extruded foam, and
(d) addition of the flame retardant of the invention and also, if appropriate, of further auxiliaries and added materials, in at least one of steps a) and/or b).

Foams of the invention based on styrene polymers, in particular EPS and XPS, are suitable by way of example for use as insulating materials, in particular in the construction industry. Preference is given to the use as halogen-free insulating material, in particular in the construction industry.

The extinguishment time of foams of the invention, in particular those based on styrene polymers, for example EPS and XPS (DIN 4102 B2 fire test using foam density 15 g/l and aging time 72 h) is ≦15 sec, particularly preferably ≦10 sec, and the foams therefore comply with the conditions required to pass the abovementioned fire test, as long as the flame height does not exceed the limit stated in the standard.

The examples below provide further explanation of, but do not restrict, the invention.

### EXAMPLES

Flame retardants (FSM) 1 to 6 used

Phosphine sulfides

| | | |
|---|---|---|
| 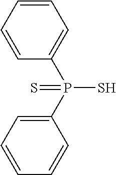 | Diphenyldithiophosphinic acid | FSM1 |
| 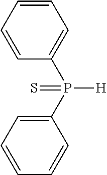 | Diphenylphosphine sulfide | FSM2 |
| 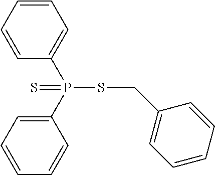 | Benzylphosphinodithioate | FSM3 |

Di- and oligophosphine chalkogenides

| | | |
|---|---|---|
| 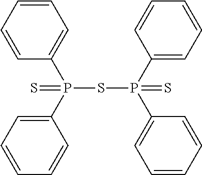 | Diphenylthiophosphinic thioanhydride | FSM4 |
| 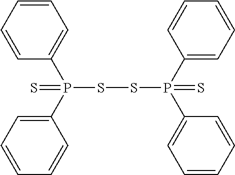 | Bis (diphenylphosphinothioyl) disulfide | FSM5 |
| 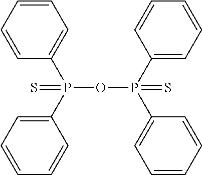 | Diphenylthiophosphinic anhydride | FSM6 |

The organophosphorus compounds used in the examples were synthesized in accordance with the following specifications:
FSM1 is commercially available (ABCR).
FSM2: Parsons, Andrew F.; Sharpe, David J.; Taylor, Philip; Synlett; 2005; 19; 2981-2983.
FSM3: K. Goda; R. Okazaki; K. Akiba; N. Inamoto; Bull. Chem. Soc. Japan; 1978; 51; 1; 260-264.
FSM4: T. R. Hopkins; P. W. Vogel; J. Amer. Chem. Soc.; 1956; 78; 4447-4450.
FSM5: M. G. Zimin; N. G. Zabirov; V. Smirnov; Zhooumal Obschei Khimii; 1980; 50; 1; 24-30.
FSM6: Maier, Ludwig; Helvetica Chimica Acta; 1964; 157; 1448-1459.

### Expandable Styrene Polymers (Extrusion Process)

7 parts by weight of n-pentane were incorporated by mixing into a polystyrene melt made of PS 148G from BASF SE with intrinsic viscosity IV 83 ml/g. Once the melt comprising blowing agent had been cooled from initially 280° C. to a temperature of 190° C., a polystyrene melt which comprised the flame retardants mentioned in the table was incorporated by mixing by way of an ancillary extruder.

The stated amounts in parts by weight are based on the entire amount of polystyrene, which corresponds to 100 parts by weight.

The mixture made of polystyrene melt, blowing agent and flame retardant was passed at 60 kg/h through a die plate having 32 holes (diameter of dies 0.75 mm). Compact pellets with narrow size distribution were produced by pressurized underwater pelletization.

The pellets were prefoamed via passage of steam an after storage for 12 hours were fused by further steam treatment in a closed mold to give foam slabs of density 15 kg/m³.

The fire behavior of the foam sheets was determined to DIN 4102 after aging for 72 hours, the foam density being 15 kg/m³.

Hexabromocyclododecane (hereinafter termed HBCD) was used as comparative example.

Table 1 collates the results:

TABLE 1
Fire behavior of EPS sheets of the invention

| | | Parts by weight, | Fire test (DIN |
|---|---|---|---|
| | | based on 100 parts | 4102 B2)/ |
| | | by weight of | extinguishment |
| Ex. | Flame retardant | polystyrene | time (s) |
| comp 1 | HBCD (comparison) | 4 | passed/6.4 s |
| 1 | FSM1 | 8 | passed/5.3 s |
| 2 | FSM2 | 8 | passed/6.2 s |
| 3 | FSM3 | 8 | passed/8.4 s |
| 4 | FSM4 | 8 | passed/6.1 s |
| 5 | FSM5 | 8 | passed/5.0 s |
| 6 | FSM6 | 8 | passed/7.2 s |
| comp 2 | 9,14-Dihydro-9-oxa- | 8 | not passed/20 s |
| | 10-phospha- | | |
| | phenanthrene 10- | | |
| | oxide (DOPO) | | |
| | (Comparison as in | | |
| | EP-A 1 791 896) | | |
| comp 3 | — | | not passed/burns |

### Extruded Polystyrene Foam Sheets

100 parts by weight of polystyrene 158K from BASF SE with intrinsic viscosity 98 ml/g, 0.1 part of talc as nucleating agent to regulate cell size, and the parts stated in the table of flame retardants, and also, if appropriate, flame retardant synergists (e.g. 2,3-diphenyl-2,4-dimethylbutane) were continuously introduced into an extruder with inner screw diameter 120 mm. At the same time, a blowing agent mixture made of 3.25 parts by weight of ethanol and 3.5 parts by weight of CO₂ was injected continuously through an inlet aperture in the extruder. The gel uniformly kneaded at 180° C. in the extruder was passed through a relaxation zone and, after a residence time of 15 minutes, conveyed with a discharge temperature of 105° C. through a shaping channel connected to the extruder, to produce a foamed sheet web with cross section 650 mm×50 mm and density 35 g/1.

The product was cut into sheets. The fire behavior of the specimens was tested for thickness 10 mm after 30 days of aging time to DIN 4102.

Table 2 collates the results of the examples.

TABLE 2
Fire behavior of XPS sheets of the invention

| | | Parts by weight, | |
|---|---|---|---|
| | | based on 100 | |
| | | parts by weight of | Fire test (DIN 4102 B2)/ |
| Ex. | Flame retardant | polystyrene | extinguishment time (s) |
| comp 4 | HBCD | 4 | passed/9.4 s |
| 7 | FSM1 | 8 | passed/6.4 s |
| 8 | FSM2 | 8 | passed/7.7 s |
| 9 | FSM4 | 8 | passed/7.5 s |
| 10 | FSM5 | 8 | passed/9.8 s |
| 11 | FSM1 + parts of | 6 | passed/6.7 s |
| | 2,3-diphenyl-2,4- | | |
| | dimethylbutane | | |
| | (synergist) | | |

The examples confirm that use of the flame retardants of the invention can produce EPS and XPS foams which, without use of halogenated flame retardants, exhibit fire behavior which is identical with or better than that obtained when the latter are used.

1-24. (canceled)

25. A method for rendering a material flame-retardant, comprising the step of the adding to the material one or more phosphine sulfide derivatives of the formula (I),
S═PR¹R²R³ (I)
wherein:
R¹ and R² are identical or different, being C₁-C₁₂-alkyl, C₃-C₈-cycloalkyl, which is optionally substituted by one or more C₁-C₄-alkyl groups as substituents, C₂-C₁₂-alkenyl, C₂-C₁₂-alkynyl, C₆-C₁₀-aryl, or C₆-C₁₀-aryl-C₁-C₄-alkyl;
R³ is H, SH, SR⁴, OH, OR⁵ or a —(Y¹)ₙ—[P(═X¹)R⁶—(Y²)ₙ]ₘ—P(═X²)R⁷R⁸ group;
or two groups R¹, R² and R³ form, together with the phosphorus atom bonded thereto, a ring system;
X¹ and X² are identical or different, being O or S;
Y¹ and Y² are identical or different, being O or S;
R⁴, R⁵, R⁶, R⁷ and R⁸ are identical or different, being independently from one another C₁-C₁₂-alkyl, C₃-C₈-cycloalkyl, which is optionally substituted by one or more C₁-C₄-alkyl groups as substituents, C₂-C₁₂-alkenyl, C₂-C₁₂-alkynyl, C₆-C₁₀-aryl, or C₆-C₁₀-aryl-C₁-C₄-alkyl;
n is 1 if Y¹ and, respectively, Y² is O, and is 1, 2, 3, 4, 5, 6, 7, or 8 if Y¹ and, respectively, Y² is S, and
m is an integer from 0 to 100.

26. The method according to claim 25, wherein
R¹ and R² are identical or different, being C₁-C₈-alkyl, cyclohexyl, phenyl or benzyl;
R³ is H, SH, SR⁴ or a —(Y¹)ₙ—[P(═X¹)R⁶—(Y²)ₙ]ₘ—P(═X²)R⁷R⁸ group;
or two groups R¹, R² and R³ form, together with the phosphorus atom bonded thereto, a ring system;
X¹ and X² are S;
Y¹ and Y² are identical or different, being O or S;
R⁴, R⁶, R⁷ and R⁸ are identical or different, being independently of one another C₁-C₈-alkyl, cyclohexyl, phenyl or benzyl;
n is 1 if Y¹ and, respectively Y² is O, and is 1 or 2 if Y² is S, and
m is an integer from 0 to 10.

27. The method according to claim 25, wherein
R¹ and R² are phenyl;
R³ is H, SH, S-benzyl, or a (Y¹)ₙ—P(═S)R⁷R⁸ group;
Y¹ is identical or different, being O or S;
R⁷ and R⁸ are phenyl;
n is 1 if Y¹ is O, and is 1 or 2 if Y¹ is S.

28. The method according to claim 25, wherein the compound(s) of the formula (I) has/have been selected from the group consisting of:
S═PR¹R²—H (Ia);
S═PR¹R²—SH (Ib);
S═PR¹R²—S-benzyl (Ic);
S═PR¹R²—S—P(═S)R⁷R⁸ (Ida);
S═PR¹R²—S—S—P(═S)R⁷R⁸ (Idb) and
S═PR¹R²—O—P(═S)R⁷R⁸ (Idc),
where the definitions of the symbols are as stated in the formula (I) according to claim 25.

29. The method according to claim 25, wherein the compound of the formula (I) is diphenyldithiophosphinic acid, diphenylphosphine sulfide, benzylphosphinodithioate, diphenylthiophosphinic thioanhydride, bis(diphenylphosphinothioyl) disulfide or diphenylthiophosphinic anhydride.

30. The method according to claim 25, wherein the moiety R³ in the formula (I) is SH, SR⁴, OH, OR⁵, or a —(Y¹)ₙ—[P(═X¹)R⁶—(Y²)ₙ]ₘ—P(═X²)R⁷R⁸ group.

31. The method according to claim 30, wherein R³ is SH, SR⁴, or a —(Y¹)ₙ—[P(═X¹)R⁶—(Y²)ₙ]ₘ—P(═X²)R⁷R⁸ group, where Y¹═S.

32. The method according to claim 31, wherein R³ is SH, or a —(Y¹)ₙ—[P(═X¹)R⁶—(Y²)ₙ]ₘ—P(═X²)R⁷R⁸ group, where Y¹═S.

33. The method according to claim 25, wherein one compound of the formula (I) is used.

34. The method according to claim 25, wherein at least two compounds of the formula (I) are added.

35. The method according to claim 25, wherein the compound(s) of the formula (I) is/are added in a mixture with one or more further flame retardants and, respectively, with one or more synergists.

36. The method according to claim 25, wherein a flame retardant according to claim 25 is added to a foamed or unfoamed polymer.

37. A polymer composition, comprising one or more polymers and a flame retardant comprising one or more phosphine sulfide derivatives of the formula (I),
S═R¹R²R³ (I)
wherein:
R¹ and R² are identical or different, being C₁-C₁₂-alkyl, C₃-C₈-cycloalkyl, which is optionally substituted by one or more C₁-C₄-alkyl groups as substituents, C₂-C₁₂-alkenyl, C₂-C₁₂-alkynyl, C₆-C₁₀-aryl, or C₆-C₁₀-aryl-C₁-C₄-alkyl;
R³ is H, SH, SR⁴, OH, OR⁵ or a —(Y¹)ₙ—[P(═X¹)R⁶—(Y²)ₙ]ₘ—P(═X²)R⁷R⁸ group;
or two groups R¹, R² and R³ form, together with the phosphorus atom bonded thereto, a ring system;
X¹ and X² are identical or different, being O or S;
Y¹ and Y² are identical or different, being O or S;
R⁴, R⁵, R⁶, R⁷ and R⁸ are identical or different, being independently from one another C₁-C₁₂-alkyl, C₃-C₈-cycloalkyl, which is optionally substituted by one or more C₁-C₄-alkyl groups as substituents, C₂-C₁₂-alkenyl, C₂-C₁₂-alkynyl, C₆-C₁₀-aryl, or C₆-C₁₀-aryl-C₁-C₄-alkyl;
n is 1 if Y¹ and, respectively, Y² is O, and is 1, 2, 3, 4, 5, 6, 7, or 8 if Y¹ and, respectively, Y² is S, and
m is an integer from 0 to 100.

38. The polymer composition according to claim 37, comprising from 0.1 to 25 parts by weight (based on 100 parts by weight of polymer) of the flame retardant.

39. The polymer composition according to claim 37, which is halogen-free.

40. The polymer composition according to claim 37, comprising a styrene polymer.

41. The polymer composition according to claim 37, wherein the polymer is a polymer foam.

42. The polymer composition according to claim 37, in the form of an expandable styrene polymer (EPS).

43. A process for producing an expandable styrene polymer (EPS) according to claim 42, comprising
a) mixing to incorporate an organic blowing agent and optionally further additives and/or auxiliaries of one or more compounds of formula (I)
S═R¹R²R³ (I)
wherein:
R¹ and R² are identical or different, being C₁-C₁₂-alkyl, C₃-C₈-cycloalkyl, which is optionally substituted by one or more C₁-C₄-alkyl groups as substituents, C₂-C₁₂-alkenyl, C₂-C₁₂-alkynyl, C₆-C₁₀-aryl, or C₆-C₁₀-aryl-C₁-C₄-alkyl;
R³ is H, SH, SR⁴, OH, OR⁵ or a —(Y¹)ₙ—[P(═X¹)R⁶—(Y²)ₙ]ₘ—P(═X²)R⁷R⁸ group;
or two groups R¹, R² and R³ form, together with the phosphorus atom bonded thereto, a ring system;
X¹ and X² are identical or different, being O or S;
Y¹ and Y² are identical or different, being O or S;
R⁴, R⁵, R⁶, R⁷ and R⁸ are identical or different, being independently from one another C₁-C₁₂-alkyl, C₃-C₈-cycloalkyl, which is optionally substituted by one or more C₁-C₄-alkyl groups as substituents, C₂-C₁₂-alkenyl, C₂-C₁₂-alkynyl, C₆-C₁₀-aryl, or C₆-C₁₀-aryl-C₁-C₄-alkyl;
n is 1 if Y¹ and, respectively, Y² is O, and is 1, 2, 3, 4, 5, 6, 7, or 8 if Y¹ and, respectively, Y² is S, and
m is an integer from 0 to 100,
into a styrene polymer melt by means of static or dynamic mixers at a temperature of at least 150° C.,
b) cooling of the blowing agent-containing styrene polymer melt to a temperature of at least 120° C.,
c) discharging through a die plate with holes, the diameter of which at the exit from the die is at most 1.5 mm, and
d) pelletizing the melt comprising blowing agent directly behind the die plate under water at a pressure in the range from 1 to 20 bar.

44. A process for the production of an expandable styrene polymer (EPS) according to claim 42, comprising
a) polymerizing one or more styrene monomers in suspension;
b) adding one or more compounds of the formula (I)
S═PR¹R²R³ (I)
wherein:
R¹ and R² are identical or different, being C₁-C₁₂-alkyl, C₃-C₈-cycloalkyl, which is optionally substituted by one or more C₁-C₄-alkyl groups as substituents, C₂-C₁₂-alkenyl, C₂-C₁₂-alkynyl, C₆-C₁₀-aryl, or C₆-C₁₀-aryl-C₁-C₄-alkyl;
R³ is H, SH, SR⁴, OH, OR⁵ or a —(Y¹)ₙ—[P(═X¹)R⁶—(Y²)ₙ]ₘ—P(═X²)R⁷R⁸ group;
or two groups R¹, R² and R³ form, together with the phosphorus atom bonded thereto, a ring system;
X¹ and X² are identical or different, being O or S;
Y¹ and Y² are identical or different, being O or S;
R⁴, R⁵, R⁶, R⁷ and R⁸ are identical or different, being independently from one another C₁-C₁₂-alkyl, C₃-C₈-cycloalkyl, which is optionally substituted by one or more C₁-C₄-alkyl groups as substituents, C₂-C₁₂-alkenyl, C₂-C₁₂-alkynyl, C₆-C₁₀-aryl, or C₆-C₁₀-aryl-C₁-C₄-alkyl;
n is 1 if Y¹ and, respectively, Y² is O, and is 1, 2, 3, 4, 5, 6, 7, or 8 if Y¹ and, respectively, Y² is S, and
m is an integer from 0 to 100,
and optionally further additives and/or auxiliaries before, during and/or after polymerization,
c) adding an organic blowing agent before, during and/or after polymerization, and
d) separating of the expandable styrene polymer particles, comprising one or more compounds of formula (I) from the suspension.

45. The polymer composition according to claim 40, in the form of an extruded styrene polymer foam (XPS).

46. A process for producing the extruded foam of a styrene polymer (XPS) according to claim 45, comprising
a) heating of a polymer component P, comprising at least one styrene polymer, to form a polymer melt,
b) introducing a blowing agent component T into the polymer melt to form a foamable melt,
c) extruding the foamable melt into a region of relatively low pressure with foaming to give an extruded foam, and
d) adding at least one compound of formula (I)
S═PR¹R²R³ (I)
wherein:
R¹ and R² are identical or different, being C₁-C₁₂-alkyl, C₃-C₈-cycloalkyl, which is optionally substituted by one or more C₁-C₄-alkyl groups as substituents, C₂-C₁₂-alkenyl, C₂-C₁₂-alkynyl, C₆-C₁₀-aryl, or C₆-C₁₀-aryl-C₁-C₄-alkyl;
R³ is H, SH, SR⁴, OH, OR⁵ or a —(Y¹)ₙ—[P(═X¹)R⁶—(Y²)ₙ]ₘ—P(═X²)R⁷R⁸ group;
or two groups R¹, R² and R³ form, together with the phosphorus atom bonded thereto, a ring system;
X¹ and X² are identical or different, being O or S;
Y¹ and Y² are identical or different, being O or S;
R⁴, R⁵, R⁶, R⁷ and R⁸ are identical or different, being independently from one another C₁-C₁₂-alkyl, C₃-C₈-cycloalkyl, which is optionally substituted by one or more C₁-C₄-alkyl groups as substituents, C₂-C₁₂-alkenyl, C₂-C₁₂-alkynyl, C₆-C₁₀-aryl, or C₆-C₁₀-aryl-C₁-C₄-alkyl;
n is 1 if Y¹ and, respectively, Y² is O, and is 1, 2, 3, 4, 5, 6, 7, or 8 if Y¹ and, respectively, Y² is S, and
m is an integer from 0 to 100,
and, optionally adding further auxiliaries and added materials, in at least one of steps a) and/or b).

47. An insulation material comprising a halogen-free polymer composition according to claim 45.

48. An insulation material comprising a halogen-free polymer composition according to claim 42 in expanded form.
